(19) United States
(12) Patent Application Publication
(10) Pub. No.: US 2003/0087089 A1
(43) Pub. Date: May 8, 2003

(54) Roll of adhesive labels for cutting tape

(76) Inventor: Peter A. Rodriguez, Jacksonville, FL (US)

Correspondence Address: Arthur G. Yeager, P.A., Suite 1305, 112 West Adams Street, Jacksonville, FL, 32202-3853, US

(21) Appl. No.: 10/008,756

(22) Filed: Nov. 8, 2001

(51) Int. Cl. B32B 7/12; B32B 15/04

(52) U.S. Cl. 428/343; 428/354

(57) ABSTRACT

A roll of adhesive members for selective attachment to a cutting tape is used for severing a traveling web of paper and transferring it to an empty spool. Each adhesive member is an elongate planar paper label element having opposite end portions and upper and lower surfaces sandwiched between an elongate planar upper adhesive layer and an elongate planar lower adhesive layer. A release liner includes a release coating on each of its upper and lower surfaces and such liner covers substantially all of the lower surface of each lower adhesive layer for supporting the adhesive members.

### CROSS REFERENCE TO RELATED APPLICATION

This application is related to an application entitled Adhesive Applicator, filed on even date herewith (Attorney Case No. D-7305A); and to an application entitled Accumulator and Dispensing System for a Cutting Tape, Filed on even date herewith (Attorney Case No. D-7305).

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to multi-layer adhesive members or elements for attachment to the ends of cutting tape used in turn up systems in the papernaking industry.

2. Related Art

It is common practice in the papermaking industries to employ a paperband or strap that is loaded into the channel of a track assembly and then removed rapidly upwardly and out of the channel and employed to cut and spool a web of paper.

A wide variety of multi-layer adhesive labels exist. What is desired is a double-sided adhesive label that can be attached to a repulpable cutting tape used in turn up in the papermaking industry. The adhesive label should also be repulpable and be adapted for use in automated handling of the label and automated attachment to a cutting tape. Preferably, the adhesive labels are formed in a large roll. No adhesive labels known in the art are suitable for the present needs.

### BRIEF SUMMARY OF THE INVENTION

In one aspect of the present invention there is provided an adhesive member for attachment to a cutting tape that is used for severing a traveling web of paper and transferring it to an empty spool comprising an elongate planar paper element having opposite end portions and upper and lower surfaces, an elongate planar upper adhesive layer having opposite end portions and upper and lower surfaces, an elongate planar upper adhesive layer having opposite end portions and upper and lower surfaces, the lower surface of the upper adhesive layer attached to and substantially covering the upper surface of the element and an elongate planar lower adhesive layer having opposite end portions and upper and lower surfaces. The upper surface of the lower adhesive layer is attached to and substantially covers the lower surface of the element. Also included is a release liner having opposite end portions and upper and lower surfaces, the upper surface of the liner covering substantially all of the lower surface of the lower adhesive layer. Alternatively, there may be an elongate planar carrier member attached to the lower surface of the lower layer for supporting the adhesive member.

The thickness of the upper layer is defined as being the distance between the upper and lower surfaces of the upper layer, said thickness being different than the thickness of the lower layer defined as being the distance between the upper and lower surface of the lower layer. The type of adhesive material constituting the upper layer may be different than the type of adhesive material constituting the lower layer.

In another aspect of the present invention there is provided an adhesive member for attachment to a cutting tape that is used for severing a traveling web of paper and transferring it to an empty spool comprising an elongate planar repulpable paper element having opposite end portions and upper and lower surfaces, an elongate planar upper adhesive layer having opposite end portions and upper and lower surfaces, the lower surface of the upper adhesive layer attached to and substantially covering the upper surface of the element, an elongate planar lower adhesive layer having opposite end portions and upper and lower surfaces, the upper surface of the lower adhesive layer attached to and substantially covering the lower surface of the element, and a release liner having opposite end portions and upper and lower surfaces, the upper surface of the liner covering substantially all of the lower surface of the lower adhesive layer. The release liner includes an elongate planar carrier member having upper and lower surfaces and being wider than the adhesive member, the lower surface of the lower layer being attached to the upper surface of the carrier member for supporting the adhesive member.

The thickness of the upper layer defined as being the distance between the upper and lower surfaces of the upper layer, said thickness being different than the thickness of the lower layer defined as being the distance between the upper and lower surface of the lower layer. The type of adhesive material constituting the upper layer may be different than the type of adhesive material constituting the lower layer.

In a further aspect of the present invention there is provided a roll of adhesive members for attachment to a cutting tape that is used for severing a traveling web of paper and transferring it to an empty spool, each adhesive member comprising an elongate planar paper element having opposite end portions and upper and lower surfaces, an elongate planar upper adhesive layer having opposite end portions and upper and lower surfaces, the lower surface of the upper adhesive layer attached to and substantially covering the upper surface of the element. An elongate planar lower adhesive layer has opposite end portions and upper and lower surfaces, the upper surface of the lower adhesive layer attached to and substantially covering the lower surface of the element and a release liner has opposite end portions and upper and lower surfaces, the upper surface of the liner covering substantially all of each lower surface of each lower adhesive layer. The release liner includes an elongate planar carrier member having upper and lower surfaces, each being wider than each adhesive member, each lower surface of each layer being attached to the upper surface of the carrier member for supporting each adhesive member. The adhesive member is mounted longitudinally medially on the upper surface of the liner, the end portions of each member being spaced apart from the end portions of another member. The carrier member has a transverse width greater than the transverse width of the adhesive members and each adhesive member is located spaced apart longitudinally from another member. Each adhesive member is located substantially medially of the upper surface of the carrier member.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description, taken in connection with the accompanying drawings, in which:

FIG. 1 is a partial top plan view of a portion of a strip of labels mounted on a carrier in accord with the present invention;

FIG. 2 is an enlarged cross-section of a portion of a label in accord with the present invention;

FIGS. 3-6 are alternative embodiments of the strip of FIG. 1; and

FIGS. 7-9 are alternative embodiments of the label of FIG. 2.

### DETAILED DESCRIPTION OF THE INVENTION

Introduction

It is a common practice in the paper industry to wind a continuous sheet or web of paper onto a rotating spool and then to cut the sheet and begin winding the paper onto another spool. Modern technology requires the cutting and spooling to be done in the shortest possible time that is reliable, economical, and safe for the reason that papermaking technology provides a continuous sheet of paper. The continuous sheet or web of paper is wound onto large spools. In order to have a continuous operation it is necessary to have a system for instantaneously switching from winding the web of paper onto a full roll to an empty roll, particularly at modern speeds of paper production. In some applications a tape is fed onto the rotating empty roll core and causing it to be spirally wrapped on that core as it stretches tight across the traveling web of paper and cuts the paper, with the cut edge being led onto the empty roll supported by the cutting tape. Subsequent improvements illustrate how a cutting tape can be passed through a guideway underneath a traveling web of paper, perhaps 10 to 20 feet or more wide and be attached to the far side of an empty spool while the operator remains on the near side of the spool. These improvements taught the use of mechanical arms to receive a cut end of the tape with adhesive on the tape, and to push the cut end into contact with the empty spool which winds the tape helically around the spool, cutting the paper web as it does, and wrapping the oncoming web around the empty spool. Processing difficulties have arisen to indicate the need for handling errors, such as the failure to apply a suitable amount of adhesive to the tape, which, in turn, means that the tape does not attach itself properly to the empty spool and therefore does not cut the traveling web of paper and transfer it to the empty spool. In the modern high-speed plants it is very important that any such errors be handled quickly and efficiently. One improvement has been to use double-sided pressure sensitive adhesive tape as the adhesive strip on the cutting tape.

The present invention provides adhesive labels or strip members with double-sided pressure sensitive adhesive (PSA) with a release liner on one side mounted on a roll and fed onto the leading portion of the cutting tape to form a pressure sensitive adhesive tape (PSAT). Some of the advantages in using adhesive labels are:

Pre-cut lengths of adhesive are applied and therefore there is no variation in length or width.

Separation of the adhesive labels from liner provides for a definite beginning and end of adhesive applied, i.e., easy to apply in an automated handling system.

Less moving parts in the applicator system.

Allows for more bulk and the nip transferring point by a factor of 5 over conventional PSAT.

Is a much more stable product since the adhesive is contained on flat paper stock carrier and not in soft tissue.

Two different types of adhesive formulation can be applied to each side of the carrier maintaining its individual characteristic.

Two individual thicknesses of adhesive can be applied to each side of substrate.

Two different types of adhesive for the same reason as above.

Conserves the repulpability status and the stability of non-repulpable PSA tapes.

Easier for manual application (easier release for liner).

More stable product physically and is resistant to thermal moisture changes.

Increased shelf life.

With respect now to the drawings, a section of a strip of labels is shown generally at numeral 10. Pressure sensitive adhesive labels 11 are mounted on a planar carrier 12 that is preferably kraft paper but other materials may be used.

Labels 11 are preferably of equal width and length and are located substantially medially on an upper surface of the carrier 12 such that outer edge portions 13 are of substantially equal width. Spaces 14 are preferably of equal length (longitudinally).

Labels 11 are applied to the leading portion of a cutting tape during each turn up of a traveling web. Accordingly, some space 14 is desired to accommodate automatic movement of the carrier 12, which is accomplished in an incremental manner.

In FIG. 2, a cross-section of a portion of a label 11 is shown with enlarged dimensions to ease of illustration. Label 11 has an upper layer 15 of pressure sensitive adhesive and a lower layer 16 also of pressure sensitive adhesive on either side of repulpable paper carrier element 17. Carrier 12 is formed as a release liner 18 that is comprised of a carrier 19 that is coated on both sides with a release coating material, such as silicone, that does not permanently bind to adhesive 16.

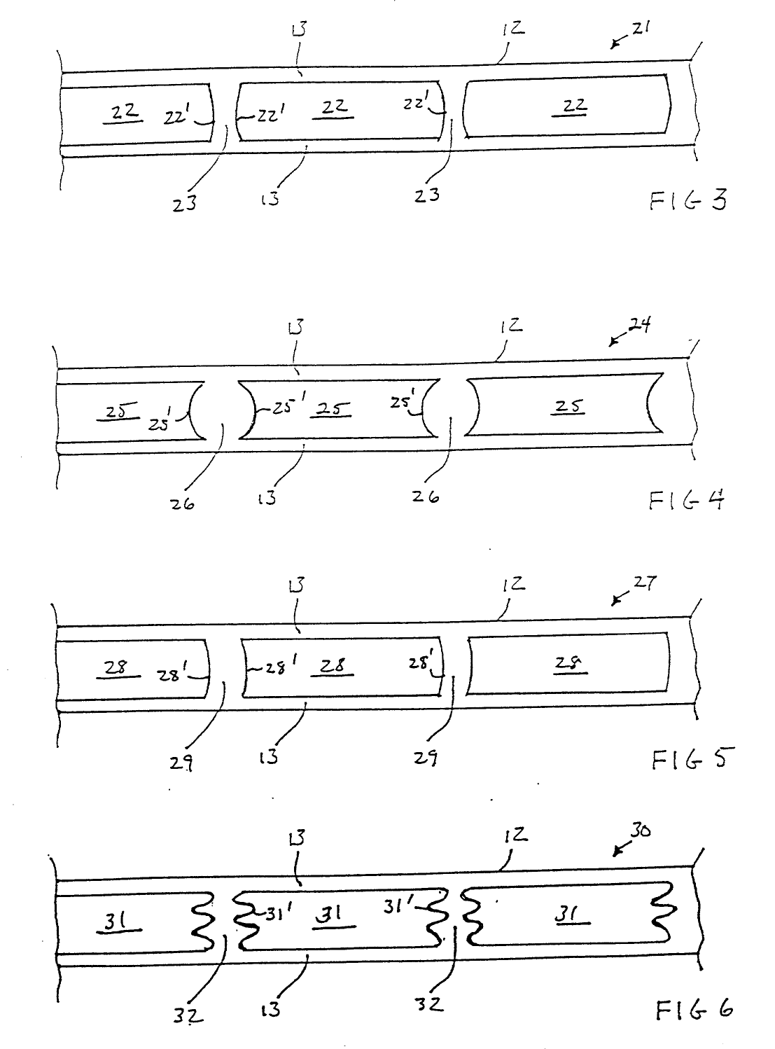

In FIG. 3, there is illustrated an alternative embodiment of a label strip 21 having labels 22 that terminate in slightly bulbous or convex end portions 22′ that are formed to improve adhesion onto a cutting tape. Spaces 23 are as before.

FIG. 4 illustrates another embodiment of a label strip 24 having labels 25 with respective end portions 25′ being crescent-shaped and spaces 26 are as before.

FIG. 5 illustrates a fourth embodiment of a strip 27 wherein labels 28 have end portions 28′ formed in a matching pattern and spaces 29 are as before.

In FIG. 6, a fifth embodiment shows a wavy or undulating pattern of end portions 31′ of labels 31 of strip 30. Spaces 32 are as before.

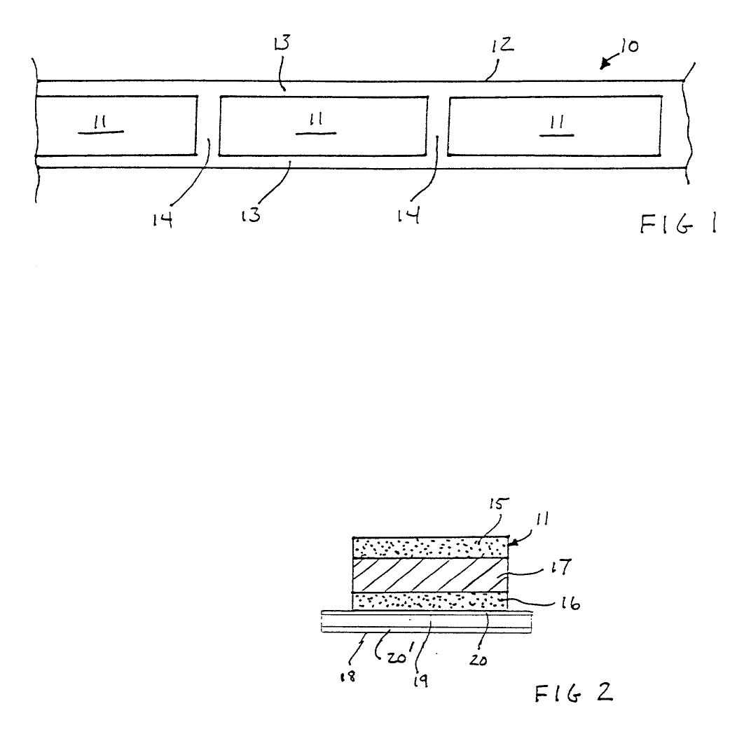

The selection of the labels shown in FIGS. 1, 2-6 depends upon the specific application and may vary with the loading speed of a cutting tape, for example.

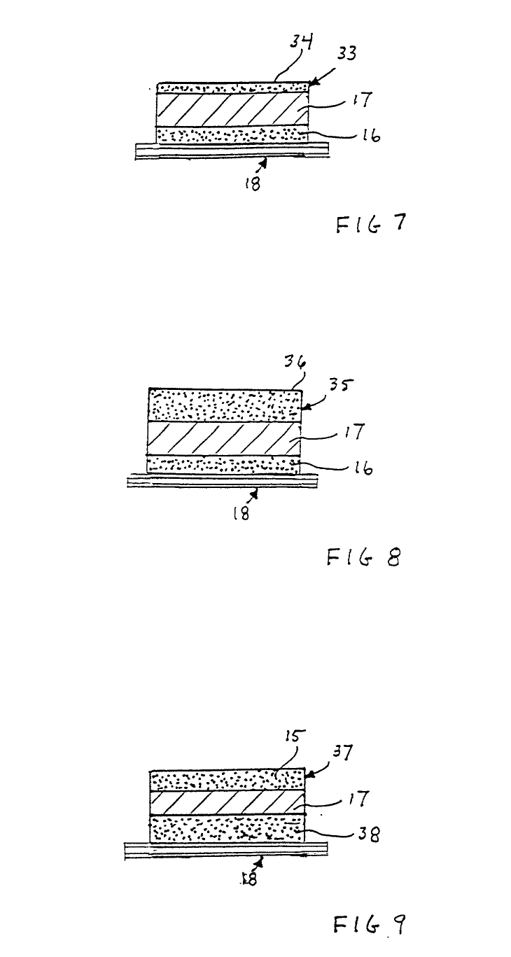

With respect to FIG. 7, an embodiment of a label 33 is shown wherein upper adhesive layer 34 is thinner than layer 15 of FIG. 2. In FIG. 9, label 37 has a thick lower layer 38.

The choice of embodiments in based on a combination of factors: first, a label is applied to a length of cutting tape by pressing a roller against one side of the tape with the upper layer of adhesive facing the other side of the tape whereby the label is attached. Accordingly, the nip between the tape and the label determines the necessary thickness of the tape/label combination at that point, the lower layer of adhesive is attached to the web after the release liner is removed. The type of adhesive used and the thickness of the lower layer depends upon the type of paper forming the web. Therefore, the thickness of the upper layer can be adjusted to ensure there is sufficient force applied at the nip to attach the label to the cutting tape.

It is important to note that the type of adhesive used in the upper and lower layers need not be the same type and the selection can be combined with the use of different thicknesses of the layers as appropriate in the circumstances. The outer layer 20′ of release layer 18 is needed because the carrier/labels combination is preferably supplied as a large roll.

The coatings 20 and 20′ may employ different materials to accommodate automatic machine handling of the strips of labels 10. The removal of a label 11 from carrier 12 and the unwinding of a roll are two different steps. The automated unwinding of a roll requires traction with layer 20′ but in a manner that will not strip the carrier 19 from the label 11 from carrier 12.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. An adhesive member for attachment to a cutting tape that is used for severing a traveling web of paper and transferring it to an empty spool comprising an elongate planar paper element having opposite end portions and upper and lower surfaces, an elongate planar upper adhesive layer having opposite end portions and upper and lower surfaces, said lower surface of said upper adhesive layer attached to and substantially covering said upper surface of said element, an elongate planar lower adhesive layer having opposite end portions and upper and lower surfaces, said upper surface of said lower adhesive layer attached to and substantially covering said lower surface of said element.

2. The member as defined in claim 1 further including a release liner having opposite end portions and upper and lower surfaces, said upper surface of said liner covering substantially all of said lower surface of said lower adhesive layer.

3. The member as defined in claim 1 further including an elongate planar carrier member attached to said lower surface of said lower layer for supporting said adhesive member.

4. The member as defined in claim 1 wherein the thickness of said upper layer is defined as being the distance between said upper and lower surfaces of said upper layer, said thickness being different than the thickness of said lower layer defined as being the distance between said upper and lower surface of said lower layer.

5. The member as defined in claim 1 wherein the type of adhesive material constituting said upper layer is different than the type of adhesive material constituting said lower layer.

6. An adhesive member for attachment to a cutting tape that is used for severing a traveling web of paper and transferring it to an empty spool comprising an elongate planar repulpable paper element having opposite end portions and upper and lower surfaces, an elongate planar upper adhesive layer having opposite end portions and upper and lower surfaces, said lower surface of said upper adhesive layer attached to and substantially covering said upper surface of said element, an elongate planar lower adhesive layer having opposite end portions and upper and lower surfaces, said upper surface of said lower adhesive layer attached to and substantially covering said lower surface of said element, and a release liner having opposite end portions and upper and lower surfaces, said upper surface of said liner covering substantially all of said lower surface of said lower adhesive layer.

7. The member as defined in claim 6 wherein said release liner includes an elongate planar carrier member having upper and lower surfaces and being wider than said adhesive member, said lower surface of said lower layer being attached to said upper surface of said carrier member for supporting said adhesive member.

8. The member as defined in claim 6 wherein the thickness of said upper layer defined as being the distance between said upper and lower surfaces of said upper layer, said thickness being different than the thickness of said lower layer defined as being the distance between said upper and lower surfaces of said lower layer.

9. The member as defined in claim 6 wherein the type of adhesive material constituting said upper layer is different than the type of adhesive material constituting said lower layer.

10. A roll of adhesive members for attachment to a cutting tape that is used for severing a traveling web of paper and transferring it to an empty spool, each said adhesive member comprising an elongate planar paper element having opposite end portions and upper and lower surfaces, an elongate planar upper adhesive layer having opposite end portions and upper and lower surfaces, said lower surface of said upper adhesive layer attached to and substantially covering said upper surface of said element, an elongate planar lower adhesive layer having opposite end portions and upper and lower surfaces, said upper surface of said lower adhesive layer attached to and substantially covering said lower surface of said element, and a release liner having opposite end portions and upper and lower surfaces, said upper surface of said liner covering substantially all of each said lower surface of each said lower adhesive layer.

11. The roll as defined in claim 10 wherein said release liner includes an elongate planar carrier member having upper and lower surfaces being wider than each said adhesive member, each said lower surface of each said layer being attached to said upper surface of said carrier member for supporting said each adhesive member.

12. The roll as defined in claim 10 wherein each said adhesive member is mounted longitudinally medially on said upper surface of said liner, said end portions of each said member being spaced apart from said end portions of another said member.

13. The roll as defined in claim 12 wherein said carrier member has a transverse width greater than the transverse width of said adhesive members, each said adhesive member being located spaced apart longitudinally from another said member.

14. The roll as defined in claim 13 wherein said each adhesive members are located substantially medially of said upper surface of said carrier member.

15. The member as defined in claim 10 wherein the thickness of each said upper layer defined as being the distance between said upper and lower surfaces of said each upper layer is different than the thickness of each said lower layer defined as being the distance between said upper and lower surfaces of said each lower layer.

16. The member as defined in claim 10 wherein the type of adhesive material constituting each said upper layer is different than the type of adhesive material constituting each said lower layer.

17. A roll of adhesive members for attachment to a cutting tape that is used for severing a traveling web of paper and transferring it to an empty spool, each said adhesive member comprising an elongate planar paper element having opposite end portions and upper and lower surfaces, an elongate planar upper adhesive layer having opposite end portions and upper and lower surfaces, said lower surfaces of said upper adhesive layer attached to and substantially covering said upper surface of said element, an elongate planar lower adhesive layer having opposite end portions and upper and lower surfaces, said upper surface of said lower adhesive layer attached to and substantially covering said lower surface of said element.

18. The roll as defined in claim 17 further including a release liner having opposite end portions and upper and lower surfaces, said upper and lower surfaces having a release coating thereon, said upper surface of said liner covering substantially all of each said lower surface of each said lower adhesive layer.

19. The roll as defined in claim 17 further including an elongate planar carrier member having upper and lower surfaces, said upper surface of said carrier member being attached to each said lower surface of each said lower layer for supporting each said adhesive member.

20. The roll as defined in claim 18 wherein each said adhesive member is mounted longitudinally medially on said upper surface of said liner, said end portions of each said member being spaced apart from said end portions another said member.

21. The roll as defined in claim 19 wherein said carrier member has a transverse width greater than the transverse width of said adhesive members, each said adhesive member being located spaced apart from another said member.

22. The roll as defined in claim 21 wherein said each adhesive members are located substantially medially of said upper surface of said carrier member.

23. The member as defined in claim 17 wherein the thickness of each said upper layer defined as being the distance between said upper and lower surfaces of said each upper layer is different than the thickness of each said lower layer defined as being the distance between said upper and lower surfaces of said each lower layer.

24. The member as defined in claim 17 wherein the type of adhesive material constituting each said upper layer is different than the type of adhesive material constituting each said lower layer.
